(19) United States
(12) Patent Application Publication
(10) Pub. No.: US 2006/0119602 A1
(43) Pub. Date: Jun. 8, 2006

(54) Address based graphics protocol

(76) Inventors: Andrew John Fisher, Cambridge (GB); Timothy Holroyd Glauert, Cambridgeshire (GB)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/005,945

(22) Filed: Dec. 7, 2004

(51) Int. Cl. G06T 11/20

(52) U.S. Cl. 345/441

(57) ABSTRACT

There is provided an apparatus and method for transmitting, over a general purpose data network, graphical data to a display device having a memory. The apparatus has a graphics component for generating graphical data in an appropriate format for direct transmission to corresponding addresses in the display device memory. Graphical data transmitted from the network interface specifies an address in the memory of that display device upon which an action is required. The apparatus is thus more efficient than conventional remote graphics systems. Direct transmission of graphical data to a memory address uses less network capacity as a single address value can generally be packed more tightly than a pair of coordinates. The invention simplifies the requirements placed on display devices: since the data is not transmitted as geometric coordinates there is no need for the display device to perform complicated arithmetic operations to convert incoming geometries to memory addresses. The network is preferably a general purpose data network and may be wireless.

### FIELD OF THE INVENTION

The present invention relates to the nature of display data transmitted across computer network architectures.

### BACKGROUND TO THE INVENTION

Computer networks have long allowed independent computers to communicate, share information, and, to an extent, share resources. However, the limitations of network technology have meant that each computer has had to remain fully functional as an independent device.

As high-bandwidth networks become more prevalent and the power of the computers connected to them continues to increase, there is a growing interest in attaching relatively dumb devices to these networks and managing them remotely. Devices which, in the past, would have needed a greater degree of autonomy and local processing power because of the limitations of the network can now be assumed to be reliably connected by a fast link to at least one computer with a powerful processor. They can therefore be much simpler, and can be managed by a computer almost as if they were its own locally-connected peripherals. This can greatly reduce the cost of the devices and the complexity of managing a network. This invention relates to the application of this model to network-connected terminals and other graphical display devices.

There are many protocols which are designed for the transmission of graphical data over digital communications links. Typically these protocols are based around graphics primitives such as ‘draw a line’, ‘fill an area’ etc, where the geometrical parameters for the primitives are based on a standard X-Y Cartesian coordinate system. An example command might be, in plain language, “Draw a black line from 0,0 to 100,0”. The terminal or remote display is responsible for interpreting these instructions and rendering the specified primitives onto its display.

The Virtual Network Computing (VNC) protocol is used for a similar purpose but operates at a somewhat lower level. In the VNC model, after some basic information has been exchanged about the pixel formats and the encodings understood by the display device, graphical data is transmitted and moved around at the pixel level, in rectangular chunks. An example VNC command would be, “Here is an update to a 10×10 rectangle with top-left coordinates 100, 100, and here are the 100 pixel values (each made up of a red, green & blue value) to put in that rectangle”

### SUMMARY OF THE INVENTION

According to a first aspect of the present invention there is provided an apparatus for transmitting, over a general purpose data network, graphical data to a display device having a memory, the apparatus comprising:

a graphics component for generating graphical data in an appropriate format for direct transmission to corresponding addresses in the display device memory; and

a network interface for transmitting the graphical data over to the display device,

wherein graphical data transmitted from the network interface specifies an address in the memory of that display device upon which an action is required.

The apparatus preferably further comprises local memory for mirroring at least a portion of the contents of the display device memory, wherein the local memory receives at least a portion of the graphical data and maintains a copy of the received data.

The graphics component may be a dedicated application executing on the apparatus and directly outputting graphical data in the appropriate format. Alternatively, the graphics component may be a device driver that intercepts graphical output from an application executing on the apparatus and converts the output into graphical data in the appropriate format.

According to another aspect of the present invention there is provided a display device for receiving graphical data transmitted over a general purpose data network, the display device comprising:

at least one display screen for presenting graphical data visually;

drive circuitry for driving the or each display screen;

a network interface for coupling the display device to the general purpose data network;

memory for storing the graphical data; and

decoder means for effecting actions directly on graphical data stored at a target address in the memory,

wherein the decoder means is adapted to receive and process graphical data transmitted to the display device, in which the graphical data specifies the target address within the memory.

The memory may have a capacity greater than that required for storing one framebuffer.

Graphical data transmitted to the network interface preferably includes an address field, specifying an address in the memory of that display device upon which an update action is required, and a data payload, which is to be written directly to the specified address, thereby updating the contents of the memory. Alternatively, the graphical data transmitted to the network interface may include a first address field, which specifies an address in the memory of the display device upon which a move action is required, and a second address field, which specifies a further address in the memory of the display device to which pre-existing contents at the first address are to be written directly, thereby updating the contents of the memory.

According to yet another aspect of the present invention there is provided a system for transmitting graphical data comprising:

at least one display device having a memory; and

a data processing device coupled to the or each display device over a general purpose data network;

wherein, in use, all graphical data transmitted by the data processing device to a given one of the display devices is transmitted to addresses in the memory of that display device that are specified by the data processing device.

The memory addresses may be directly specified in the transmitted graphical data.

Alternatively, the memory addresses may be deduced from addresses previously specified in transmitted graphical data.

It is preferred that the transmitted graphical data incorporates flags, which specify that addresses are to be repeated from the previous command.

The display device may perform an arithmetic operation on the address data transmitted to it before directing addressed data to a new address in local memory data. The arithmetic operation may be an addition of an offset value, thereby facilitating offset mapping. Alternatively, the arithmetic operation is a paging operation, thereby facilitating memory paging.

According to a still further aspect of the present invention there is provided a method for transmitting, over a general purpose data network, graphical data to a display device having a memory, the method comprising:

generating graphical data in an appropriate format for direct transmission to corresponding addresses in the display device memory; and

transmitting the graphical data over to the display device,

wherein graphical data transmitted from the network interface specifies an address in the memory of that display device upon which an action is required.

The method may further comprise mirroring, in local memory, at least a portion of the contents of the display device memory, wherein the local memory receives at least a portion of the graphical data and maintains a copy of the received data.

The step of generating graphical data preferably comprises executing a dedicated application on the apparatus and directly outputting graphical data in the appropriate format.

Alternatively, the step of generating graphical data comprises executing a software device driver that intercepts graphical output from an application executing on the apparatus and converts the output into graphical data in the appropriate format.

The graphical data preferably further includes a data payload, which is to be written directly to the specified address, thereby updating the contents of the memory.

Alternatively, the graphical data may further include a second address field which specifies a further address in the memory of the display device to which pre-existing contents at the first address are to be written directly, thereby moving the contents of the memory at the first address to memory at the second address.

The present invention provides for a more efficient remote graphics system than the previous art. Graphical data is sent directly to addresses in the memory of the display device. In general, this will use less network capacity as a single address value can generally be packed more tightly than a pair of coordinates.

The network in this system is a general purpose data network and may be wireless. The preferred general purpose data network is an ethernet operating at 100 Mb/s, but other networks are also suitable, such as 10 Mb/s and 1 Gb/s or Universal Serial Bus (USB), IEEE-1394 (Firewire), Asynchronous Transfer Mode (ATM), Bluetooth, Infrared Data Association (IRDA), 802.11 based and Ultra Wide Band (UWB) wireless networks.

The present invention further provides for less complex display devices than was possible previously. Since the data is not transmitted as geometric coordinates there is no need for the display device to perform arithmetic to convert incoming geometries to memory addresses.

The graphical data uses memory addresses on the display device for all operations. The memory addresses may be directly specified, or may be deduced, for example an indication may be given that addresses should follow on consecutively from the last instruction. They will typically map directly on to the memory locations at the display device, though they may be converted by some simple operation such as the addition of an offset or the selection of a particular memory page. Separate mechanisms are used to describe and specify the mapping of memory locations to pixels on the screen.

Preferably, the data incorporates flags which specify that addresses are to be repeated or continued from the previous command. This reduces unnecessary repetition of addresses.

In the case that a copy of at least a portion of the display device memory is also maintained at the data processing device the present invention improves the efficiency of transferring data from the memory of the data processing device to the display device. For example because an update to a large area of the display often results in updates to long runs of consecutive memory locations on both the data processing device and the display device. Such long runs are more efficiently handled by both processor and memory architectures.

Each display device in the system of the present invention includes a network interface, memory for storing the image data, and circuitry for driving the display from the received data. The network interface, drive circuitry and memory may all be embedded within the display device, incorporated within a cable connected to the display, incorporated within a power plug or adapter connected to the display or be packaged in a separate device to which both the network and display are connected (i.e. a network to video converter). Thus, existing conventional displays can simply be made compatible with the system of the present invention.

Preferably, each display device has greater memory than that required for storing a single framebuffer. Examples of the use of this extra memory as off-screen graphics include caching and double buffering. In the process of caching regularly used graphics, such as fonts and icons, are held in an off-screen area of memory and are copied to the display area as and when they are needed. If the system uses double-buffering, the screen image is created by writing to an area of memory which is not currently displayed, and then, when a coherent state is reached, that memory is switched to be the currently-displayed area, and further updates are made to the memory that was previously displayed. The system of the present invention uses the same mechanism to update off-screen graphics and on-screen graphics. This increases the simplicity and efficiency of the system.

While it is common for a single pixel to be represented in memory by a number of consecutive bytes, e.g. one each for the red, green and blue values, that is by no means the only mapping used. Sometimes there is a separate layer used to specify overlays, such as subtitles, or cursors, or brightness, or transparency. Sometimes an area of memory is used as a colour-map, a translation table from memory values to pixel colours. With a coordinate-based system, a separate mechanism is needed to modify these additional areas. With the memory-address-based system of the present invention, the same mechanism can be used as is used for changing simple pixel values.

The mapping of memory to screen is changed by operations such as double-buffering, scrolling, and resolution changes. These changes will affect a coordinate-based system and so require synchronisation between the mapping changes and the graphics. In the address-based system of the present invention, these activities are independent, allowing for more efficient operation. For example, if the display memory on the remote device holds the image of a page, much of the work of scrolling it up and down may be achieved simply by changing the part of the display memory which is being shown on the screen.

The display device may be arranged to drive more than one display screen from separate and/or overlapping areas of the same display device memory. Consequently, one mechanism may be used to update any of the display screens simply by updating the appropriate areas of memory, without the need for a separate means of specifying the target screen. A single graphical data transmission may therefore be used to update multiple screen at once, for example to clear multiple displays to black, or to copy data between displays.

The system of the present invention makes the basic protocol independent of the way that the memory is interpreted, supporting 8-, 16-, 24- and 32-bit pixels in a uniform way. It is possible to make graphical updates which do not directly correspond to whole pixels—e.g. changing just one byte of a 24-bit pixel.

### BRIEF DESCRIPTION OF THE DRAWINGS

Examples of the present invention will now be described in detail with reference to the accompanying drawings, in which:

FIG. 1 is a schematic illustration of the component parts of a data processing device and a display device in accordance with one example of the present invention;

FIG. 2 illustrates a first network topology of the present invention;

FIG. 3 illustrates a second network topology of the present invention;

FIG. 4 illustrates a third network topology of the present invention;

FIG. 5 illustrates the direct transmission of an update packet into memory in an display device in accordance with the present invention; and

FIG. 6 illustrates the direct transmission of a move packet to a display device in accordance with the present invention.

### DETAILED DESCRIPTION

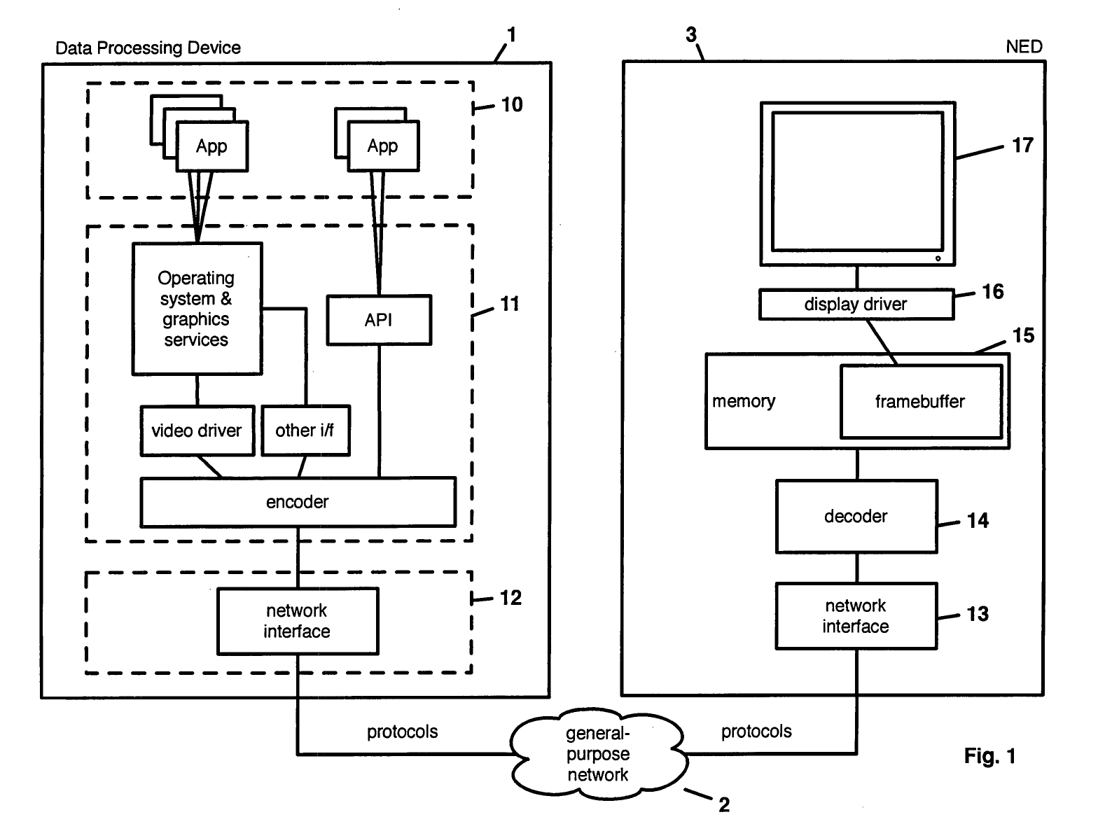

Referring to FIG. 1, a system in accordance with the present invention requires a data processing device 1 (such as a personal computer, laptop or PDA) from which image data is transferred and a display device 3 connected to the data processing device 1 over a network 2. A display device 3 of this sort will hereinafter be referred to as a network enabled display (NED 3).

FIG. 1 shows a data processing device 1 running applications 10, software and/or hardware components 11 for converting graphical data and a network interface 12. The NED 3 includes a network interface 13, a decoder 14, a memory 15 and display driver 16, as well as a display screen 17.

A typical implementation of the present invention in which data is displayed on a display device will now be described with reference to FIG. 1, in terms of the specific steps the data goes through.

First, an application or group of applications 10 on the data processing device 1 creates some graphical output. The application might, for example, draw some text or display an image. The application may have the facilities to render the graphical output into pixels itself, it may make use of some library software which provides graphics services, or it may use a graphics protocol or other description of the desired output. In the following example a single application is described, but it should be noted that the invention is applicable to multiple applications, typically those creating a workspace environment belonging to a particular user of the system.

The graphical output is then converted on the data processing device 1 by one or more software or hardware components 11 into a form suitable for sending over a network connection to a display.

This stage may be implemented in a number of ways. A software device driver may intercept graphical data from an existing application, convert it into data suitable for a NED and transmit that data across the network. Alternatively, the application may be written in the knowledge that it will be driving a NED and therefore create NED compatible output itself.

It is recognised that there are other possible methods to capture the graphical output of an application and translate and transmit it in the low-level commands understood by a NED. These commands include pixel data and other operations for manipulating the display, as described below.

Pixel data included in the command stream may be in ‘raw’ form or may be compressed in some way. The data compression/decompression method used will in general be lossless. An encryption engine may be used to encrypt the pixel/command data before it is sent over the network.

Referring again to FIG. 1, the network interface subsystem 13 on each NED 3 receives data intended for that NED 3. Generally this will be specifically addressed to the individual display, although it may also be data which is broadcast or multicast to multiple NEDs 3.

The received data is decoded at decoder 14. This may involve a security/decryption unit. The data intended for display is converted into a form suitable for writing into a framebuffer or cache. The data may also include commands which manipulate the framebuffer, cache or the display in other ways. The COPY command described below is a typical example.

Pixel data is written into the framebuffer directly or into other memory 15 for possible future display or manipulation by later commands. A subsystem 16 is responsible for taking the data in the framebuffer and using it to drive the display. This process is well understood in the art and will depend on the nature of the display used.

In the following description of the protocols that may be used, the term ‘length’ refers to a measure of the amount of data being sent. Data is directed to a memory address at the display device. For this reason this type of protocol will be referred to as an address-based graphics protocol.

Commands that may be sent to the NED 3 include but are not limited to:

RAW—Raw Pixel Data

This command is accompanied by an address, a length, and the amount of pixel data specified by the length, which is to be written into the NED's 3 memory at the specified address.

RLE—Run-Length Encoded Pixel Data

This is similar to RAW except that the pixel data is encoded as one or more repetitions of (count, value), each indicating that the specified number of pixels of the given value should be written into memory.

COPY—Copy Pixel Data

This command is accompanied by a source address, a destination address, and a length indicating the amount of data to be copied from the former to the latter.

SYNC—Framebuffer Ready

Most NEDs 3 will have at least two framebuffers, to allow for double-buffering of the display, and this command indicates that a framebuffer has been updated to a consistent ‘complete’ state and is suitable for displaying to the user.

In one embodiment, each command is represented by a particular byte value and is followed by its arguments in the data stream. Typically it is possible to incorporate flags in the data which specify that addresses are to be repeated or continued from the previous command. This reduces unnecessary repetition of addresses. All pixel data is written directly to a memory address and any offsets are directly incorporated in that manner.

Information sent from the NED 3 back to the data processing device 1 typically includes confirmation of the above commands and status information.

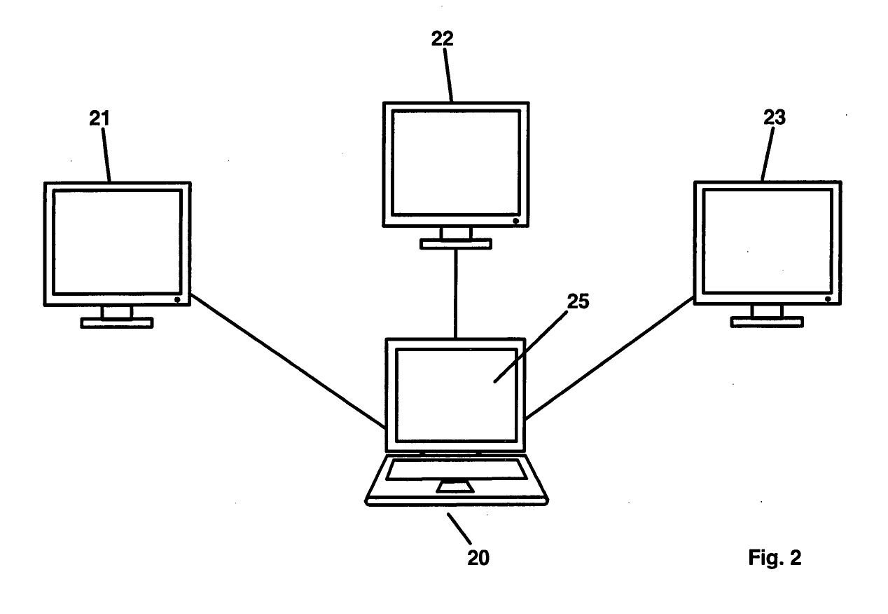

The address-based protocol of the present invention is highly effective for use in a number of applications. For example, the process of adding multiple screens to a computer for the purpose of providing an expanded desktop. The address-based protocol of the present invention provides a more efficient method of transmitting the graphical data in this process than was previously available. FIG. 2 illustrates a first network topology of this process. A data processing device is illustrated as a laptop computer. The data processing device 20 has its own conventional display device 25 but is also connected to a number of NEDs 21, 22, 23. As shown each NED 21,22,23 has its own dedicated connection to the host. Alternatively, the NEDs 21,22,23 can be simply plugged into the same network as the machine, or into another network to which it has access, and an association is made in software between those NEDs 21,22,23 and the particular computer.

Software or hardware on the data processing device 20 may make the extra NEDs 21,22,23 appear to be part of the same workspace shown on the main screen, typically by emulating a graphics card or driver software in the manner described in co-pending US patent application with attorney docket number PJF01808US, so that programs running on the data processing device 20 are unaware that their output is being displayed on a NED 21,22,23. In a typical scenario, windows on the conventional screen 25 can be moved across to the NED 21,22,23 simply by dragging them off one side of the main display. A simple user interface would generally be provided to enable users to control which NEDs 21,22,23 were part of this extended workspace, the geometric relationship between them and any conventional displays, and other aspects of the system.

A further use of the address-based protocol of the present invention is in the process of adding multiple screens which aren't intended to be part of the workspace of a computer. For example, a NED which displays a slide show in a shop window is only visible from the outside of the building. These displays may also be at a greater distance from the data processing device than would be easily possible with conventional display-driving mechanisms. For whatever reason, interacting with the NED as if it were simply part of the main display may not be ideal.

In these cases, software is written or modified to be compatible with NEDs and to drive one or more of them explicitly. A typical use might be the control of multiple displays on a railway platform for informational and/or advertising purposes. The host machine may also have some displays running conventional desktop applications, but this is not necessary, and indeed it may not normally have a ‘user’ at all in the conventional sense. NEDs may also be driven by consumer electronics devices such as central heating controllers, games machines or voicemail systems. Again, the use of the address-based protocol of the present invention increases the efficiency of the system.

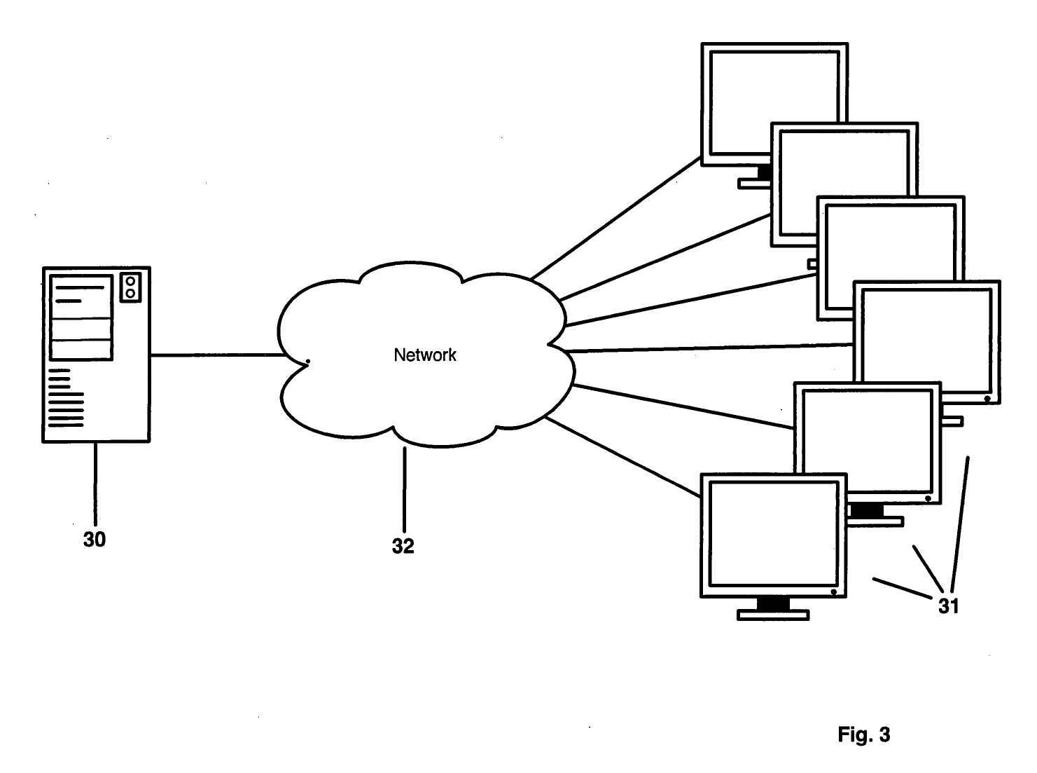

FIG. 3 shows a network topology in which a single data processing device 30 is connected over a general purpose data network 32 to a plurality of NEDs 31. The illustrated data processing device 30 does not have its own conventional display device.

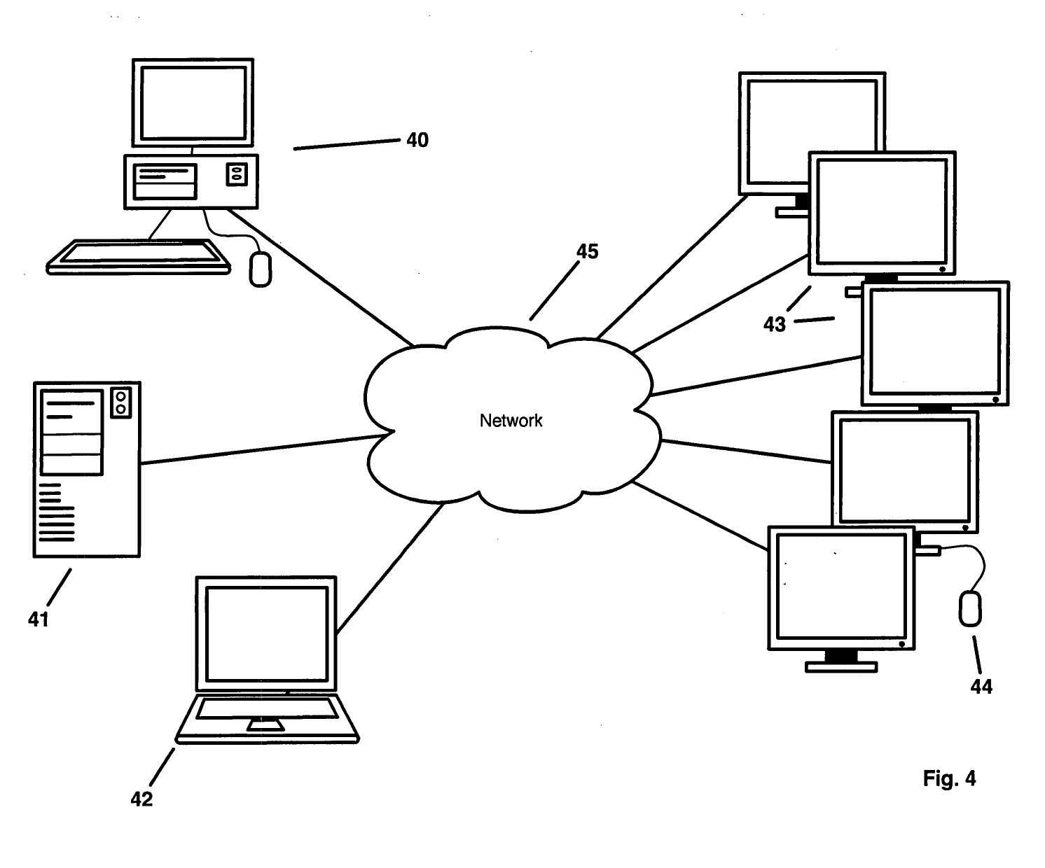

FIG. 4 shows a more complex network arrangement including other network devices such as a PC 40 including keyboard and mouse, a server 41 and a laptop 42 and NEDs 43. A mouse 44 is also shown connected to one of the display devices 43. Any number of devices may be added to the network 45 and may be dedicated to particular tasks such as a display for displaying the time, or a server for providing network management. The NEDs 43 may support a keyboard and pointer, or other input and output devices, whose data is fed back to the driving machine. Each of these added peripherals will have its own network address. Many of these terminals may be connected to one machine. Again, this system benefits from increased efficiency if it adopts the address-based protocol of the present invention.

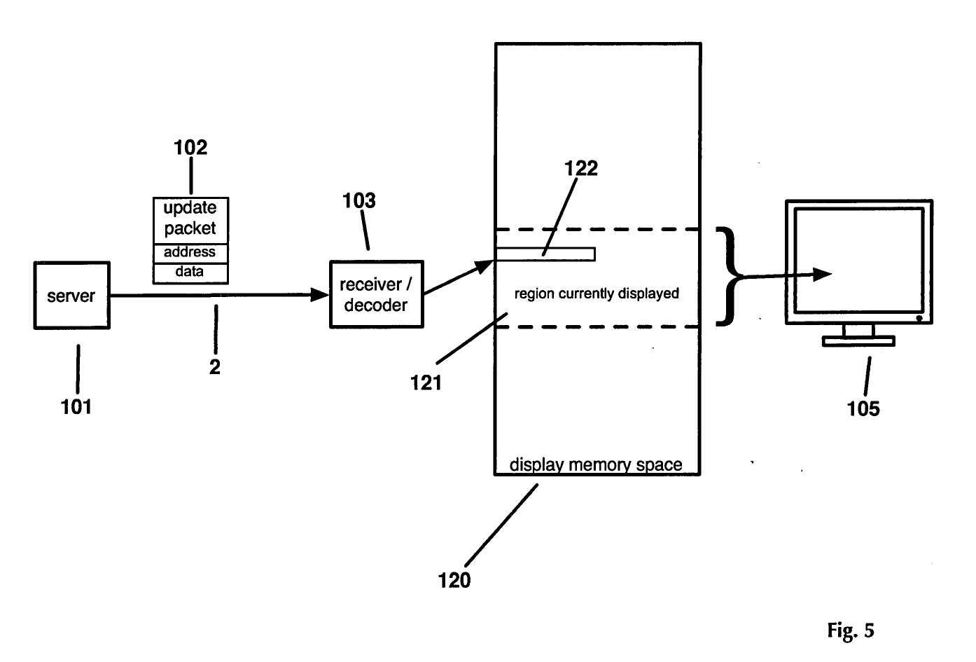

FIG. 5 illustrates the direct transmission of an update packet 102 of graphical data to an address 122 in display memory 120 of an display device in accordance with the present invention. The data processing device, server 101, transmits the update packet 102 across a network 2 to a display device 103, 120,105. The update packet 102 is received at receiver/decoder 103 where the address field of the packet is interpreted as a corresponding address in display memory space 120. The packet's data payload is written by the decoder 103 to a portion of memory corresponding to the current display 121, thereby updating the signal that will be displayed on the display screen 105. This address-based operation corresponds to the execution of a RAW command in the case of an NED.

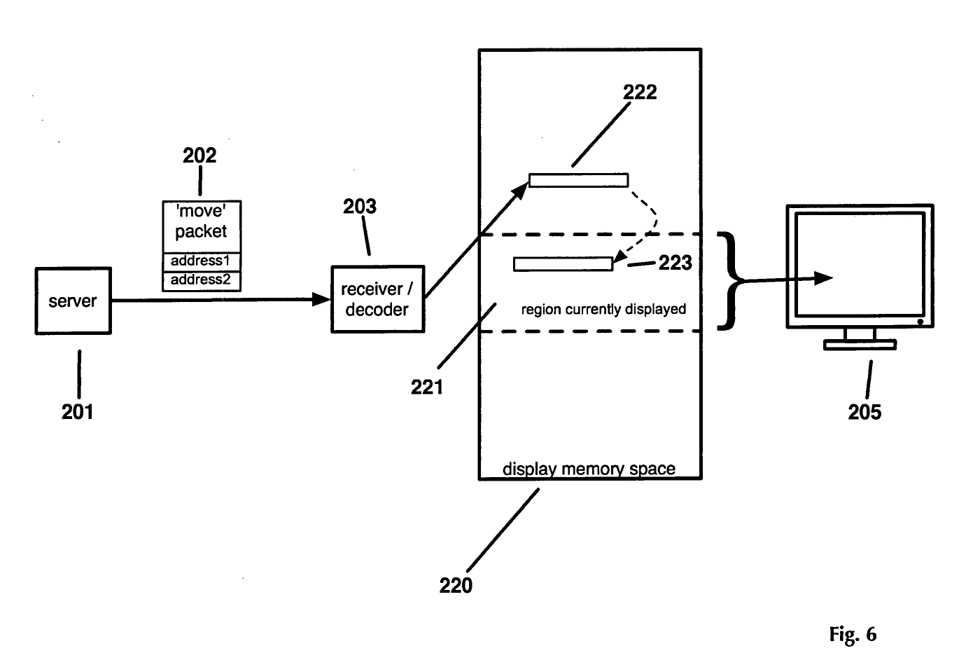

FIG. 6 illustrates transmission of a move packet 202 of graphical data to a display device 203,220,205. The move packet 202 directs receiver/decoder 203 to take the pre-existing contents at a first address 222 of display memory 220 and to copy/move the contents to a second address 223 in the display memory 220. In the illustrated example, the second address 223 is in a portion of memory corresponding to the current display 221, thereby updating the signal that will be displayed on the display screen 205. This operation corresponds to the execution of a COPY command in the case of an NED.

Although not illustrated, the system of the invention may perform other address-based operations, in addition to the copy/move and update operations. Examples of other operations include: a “merge” operation, where source data and destination data is combined using various basic operations (e.g. standard boolean logic operations, multiplicative operations, interpolative operations, or masking operations); and a “fill” operation, in which a block of memory may be filled with a single colour (this is a special case of the RLE command).

The present invention can be used to improve the simplicity and efficiency of many remote graphics applications, and is not limited to use in the specific implementations described above.

1. An apparatus for transmitting, over a general purpose data network, graphical data to a display device having a memory, the apparatus comprising:
a graphics component for generating graphical data in an appropriate format for direct transmission to corresponding addresses in the display device memory; and
a network interface for transmitting the graphical data over to the display device,
wherein graphical data transmitted from the network interface specifies an address in the memory of that display device upon which an action is required.

2. An apparatus as claimed in claim 1, further comprising local memory for mirroring at least a portion of the contents of the display device memory, wherein the local memory receives at least a portion of the graphical data and maintains a copy of the received data.

3. An apparatus as claimed in claim 1 or claim 2, wherein the graphics component is a dedicated application executing on the apparatus and directly outputting graphical data in the appropriate format.

4. An apparatus as claimed in claim 1 or claim 2, wherein the graphics component is a device driver that intercepts graphical output from an application executing on the apparatus and converts the output into graphical data in the appropriate format.

5. A display device for receiving graphical data transmitted over a general purpose data network, the display device comprising:
at least one display screen for presenting graphical data visually;
drive circuitry for driving the or each display screen;
a network interface for coupling the display device to the general purpose data network;
memory for storing the graphical data; and
decoder means for effecting actions directly on graphical data stored at a target address in the memory,
wherein the decoder means is adapted to receive and process graphical data transmitted to the display device, in which the graphical data specifies the target address within the memory.

6. A display device as claimed in claim 5, wherein the memory has a capacity greater than that required for storing one framebuffer.

7. A display device as claimed in either claim 5 or claim 6, wherein graphical data transmitted to the network interface includes an address field, specifying an address in the memory of that display device upon which an update action is required, and a data payload, which is to be written directly to the specified address, thereby updating the contents of the memory.

8. A display device as claimed in either claim 5 or claim 6, wherein graphical data transmitted to the network interface includes a first address field, which specifies an address in the memory of the display device upon which a move action is required, and a second address field, which specifies a further address in the memory of the display device to which pre-existing contents at the first address are to be written directly, thereby updating the contents of the memory.

9. A system for transmitting graphical data comprising:
at least one display device having a memory; and
a data processing device coupled to the or each display device over a general purpose data network;
wherein, in use, all graphical data transmitted by the data processing device to a given one of the display devices is transmitted to addresses in the memory of that display device that are specified by the data processing device

10. A system as claimed in claim 9, wherein the memory addresses are directly specified in the transmitted graphical data.

11. A system as claimed in claim 9, wherein the memory addresses are deduced from addresses previously specified in transmitted graphical data.

12. A system as claimed in claim 9, wherein the transmitted graphical data incorporates flags, which specify that addresses are to be repeated from the previous command.

13. A method for transmitting, over a general purpose data network, graphical data to a display device having a memory, the method comprising:
generating graphical data in an appropriate format for direct transmission to corresponding addresses in the display device memory; and
transmitting the graphical data over to the display device,
wherein graphical data transmitted from the network interface specifies an address in the memory of that display device upon which an action is required.

14. A method as claimed in claim 13, the method further comprising:
mirroring in local memory at least a portion of the contents of the display device memory, wherein the local memory receives at least a portion of the graphical data and maintains a copy of the received data.

15. A method as claimed in claim 14, wherein the step of generating graphical data comprises executing a dedicated application on the apparatus and directly outputting graphical data in the appropriate format.

16. A method as claimed in claim 14, wherein the step of generating graphical data comprises executing a software device driver that intercepts graphical output from an application executing on the apparatus and converts the output into graphical data in the appropriate format.

17. A method as claimed in claim 13, wherein graphical data transmitted from the network interface includes one or more address field and/or one or more data payload, wherein the action required at the address is dependent upon the contents of the graphical data.

18. A method as claimed in claim 17, wherein graphical data includes a data payload and wherein the transmission of graphical data includes writing the data payload directly to the specified address, thereby updating the contents of the memory.

19. A method as claimed in claim 17, wherein the graphical data includes a target address field, and wherein the transmission of graphical data includes:
determining from the graphical data a source address upon which the action is required;
determining from the graphical data the target address in the memory of the display device to which pre-existing contents at the address are to be written directly; and
writing the contents at the address directly to the specified target address, thereby moving the contents of the memory at the source address to memory at the target address.
